(19) United States
(12) Patent Application Publication
(10) Pub. No.: US 2008/0062154 A1
(43) Pub. Date: Mar. 13, 2008

(54) Structure of digital flat panel display

(76) Inventors: Chih-hsien Chang, Hsinchu (TW); Pai-Nan Ni, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/592,184

(22) Filed: Nov. 3, 2006

(30) Foreign Application Priority Data
Sep. 12, 2006 (TW) 95133673

(51) Int. Cl. G09G 5/00

(52) U.S. Cl. 345/204

(57) ABSTRACT

A digital flat panel display includes a case, a display module and an electrical control system. The electrical control system comprises a signal-input terminal to connect with the display module for receiving signals. A signal input/output module is located at the upper area of the signal-input terminal to process the I/O signals. A signal transform module is located at the upper area of the signal-input terminal to convert the analog signals to the digital signals and a power supply module is located at least one upper position of the signal transform module to transform a power source and provide the power source for the signals operation.

### BACKGROUND OF THE INVENTION

1. Field of the Invention

The present invention generally relates to the digital flat panel display, and more particularly, to the layout of the digital flat panel display.

2. Description of the Prior Art

FIG. 1, FIG. 2, FIG. 3 and FIG. 4 are conventional perspective layouts of the digital flat panel display. As FIG. 1 shown, the digital flat panel display includes a case 1A, a display module 10 and an electrical control system 1B. The electrical control system 1B includes a signal-input terminal 12, a power supply module 14, a signal transform module 16 and a signal input/output module 18. Generally speaking, the signal-input terminal 12 connected to the display module 10 is positioned on the upper position of the display module 10. The power supply module 14 is located at the middle position of the display module 10. The signal transform module 16 and the signal input/output module 18 are at the lower position of the display module 10.

One disadvantage of such a structural layout is that the signal line 101 crossing the power supply module 14 is subject to interference and decayed due to longer line. Furthermore, the power supply module 14 generates and accumulates the heat to affect the signals transmitting, which shorten the lifetime. As FIG. 2 and FIG. 3 shown, the position of the power supply module 14 is shifted to left or right side to prevent signals from being interfered. However, the signal-input terminal 12 is at the upper area of the power supply module 14, and the problem of the accumulated heat still exists inside the power supply module 14.

As FIG. 4 shown, the signal transform module 16, the signal input/output module 18 and a TV box module 15 are configured at the lower area of the signal-input terminal 12 to shorten the length of the signal line 101, and prevent from the weakness of the signal and interferences. But, the power supply module 14 is located at the lower position of the display module 10 to cause the heat passing through the signal transform module 16, the signal input/output module 18 and the TV box module 15, which may be damaged the display module 10 easily when the heat is accumulated inside the digital flat panel display.

### SUMMARY OF THE INVENTION

In order to improve the heat is accumulated inside a digital flat panel display, a structure of the digital flat panel display is provided to rearrange certain modules therein.

In order to shorten the length of a signal line inside a digital flat panel display for decreasing the weakness of signals, a structure of the digital flat panel display is provided to rearrange certain modules.

In order to prevent the phenomena of the signals weakness and interferences of a digital flat panel display, the structure of a digital flat panel display is provided to rearrange certain modules, and a signal line is not to be crossed a power supply module.

Accordingly, one embodiment of the present invention provides a digital flat panel display structure, including a case, a display module and an electrical control system. The electrical control system includes a signal-input terminal connected with the display module for receiving signals; a signal input/output module connected to the display module and configured at the upper area of the signal-input terminal to process the I/O signals; a signal transform module connected to the display module and located at the upper area of the signal-input terminal to convert the analog signals to the digital signals; and a power supply module connected to the display module and configured at the upper area of any one position of the signal transform module and the signal input/output module for transforming a power source and providing the power source.

Another embodiment of the present invention provides a digital flat panel display structure, including a case, a display module and an electrical control system. The electrical control system includes a signal-input terminal connected with the display module for receiving signals; a signal input/output module connected to the display module and configured at the upper area of the signal-input terminal to process the I/O signals; a TV box module connected to display module and configured at the upper area of the signal-input terminal; a signal transform module connected to the display module and located at the upper area of the signal-input terminal to convert the analog signals to the digital signals; a power supply module connected to the display module and configured at the upper area of any one position of the signal transform module, the signal input/output module and the TV box module for transforming a power source and providing the power source for the signals operation.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a perspective diagram illustrating conventional layout of the digital flat panel display;

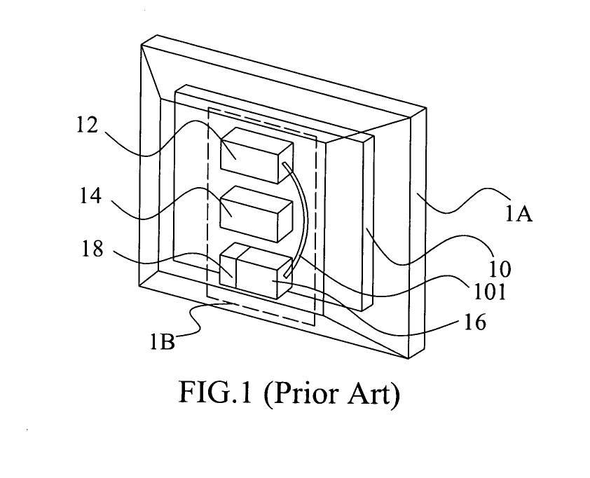

FIG. 2 is a perspective diagram illustrating conventional layout of the digital flat panel display;

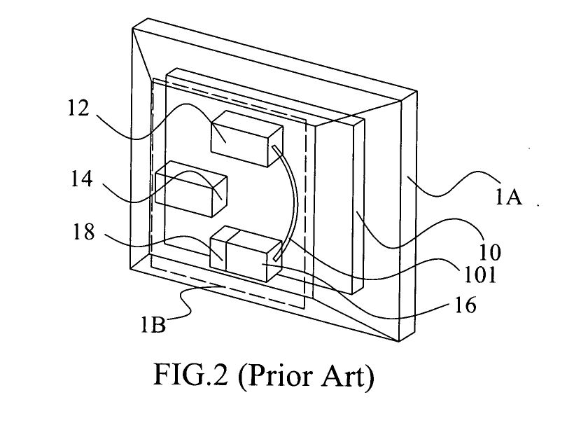

FIG. 3 is a perspective diagram illustrating conventional layout of the digital flat panel display;

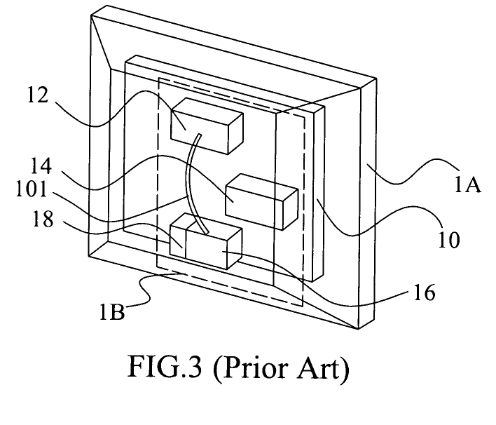

FIG. 4 is a perspective diagram illustrating the conventional layout of the digital flat panel display;

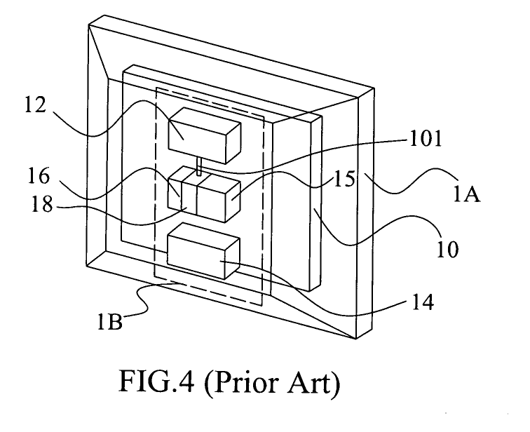

FIG. 5 is a perspective diagram illustrating the layout of the digital flat panel display in accordance with an embodiment of the present invention;

FIG. 6 is a perspective diagram illustrating the layout of the digital flat panel display in accordance with an embodiment of the present invention;

FIG. 7 is a perspective diagram illustrating the layout of the digital flat panel display in accordance with an embodiment of the present invention; and

FIG. 8 is a perspective diagram illustrating the layout of the digital flat panel display in accordance with an embodiment of the present invention.

### DESCRIPTION OF THE PREFERRED EMBODIMENT

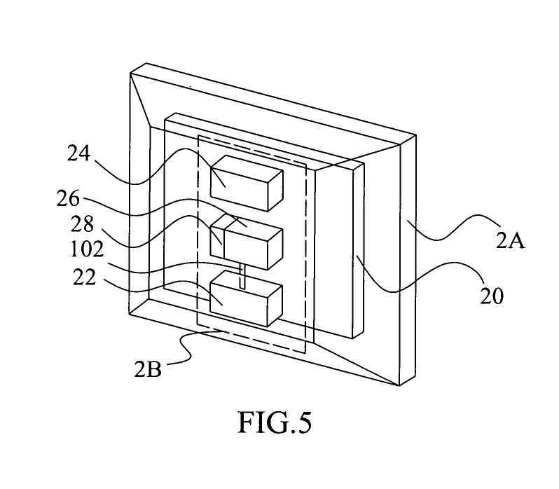

FIG. 5 is a perspective diagram illustrating the layout of the digital flat panel display in accordance with an embodiment of the present invention. In one embodiment, the digital flat panel display includes a case 2A, a display module 20 and an electrical control system 2B. The electrical control system 2B includes a signal-input terminal 22 for receiving signals, a power supply module 24 transforms a power source and provides the power source for signals operation, a signal transform module 26 converts the analog signals to the digital signals, and a signal input/output module 28 processes the I/O signals.

In one embodiment, the display module 20 is rotated 180 degree so as to rearrange the signal-input terminal 22 at the lower position of the display module 20 and the power supply module 24 at the upper position of the display module 20. Besides, the signal transform module 26 and the signal input/output module 28 are between the signal-input terminal 22 and the power supply module 24. In addition, the display module 20 controls the image to return the image back to the original direction by an electrical firmware (not shown).

Accordingly, a signal line 102 is not crossed the power supply module 24 to cause the interferences of the signals. Besides, the signals are not weakness with long transmitting distance. Further more, the power supply module 24 does not produce and accumulate the heat, that is shorten the lifetime of the digital flat panel display during operation.

Accordingly, the power supply module 24 produces the higher temperature of the lower density of air where surrounding the display module 20 so as to the higher temperature of air is dissipated to the outside area directly, and the heat is not accumulated inside the display module 20 for forming the good solution for dissipating the heat.

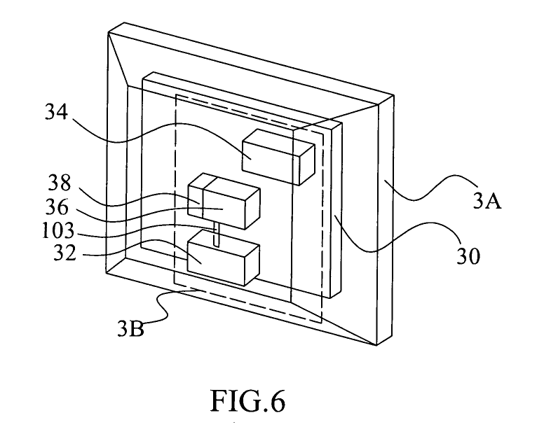

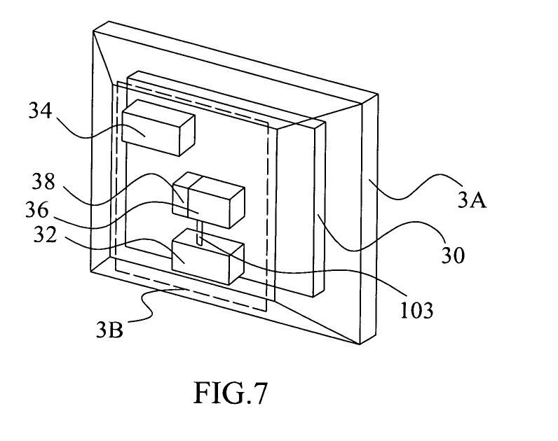

FIG. 6 and FIG. 7 are the perspective diagrams illustrating the layout of the digital flat panel display in accordance with one embodiment of the present invention.

As FIG. 6 shown, the flat panel display includes a case 3A, a display module 30 and an electrical control system 3B. The electrical control system 3B includes a signal-input terminal 32 for receiving signals, a power supply module 34 transforms a power source and provides the power source, a signal transform module 36 converts the analog signals to the digital signals, and a signal input/output module 38 processes the I/O signals.

In this embodiment, the display module 30 is rotated 180 degree so as to rearrange the signal-input terminal 32 at the lower position of the display module 30 and the power supply module 34 at the upper-right side of the display module 30. Besides, the signal transform module 36 and the signal input/output module 38 are between the signal-input terminal 32 and the power supply module 34.

As FIG. 7 shown, the display module 30 is rotated 180 degree so as to rearrange the signal-input terminal 32 at the lower position of the display module 30 and the power supply module 34 at the upper-left side of the display module 30. Besides, the signal transform module 36 and the signal input/output module 38 are between the signal-input terminal 32 and the power supply module 34.

Therefore, according to the spirit of one embodiment, the power supply module 34 is located at least any one upper position of the digital flat panel display to dissipate the heat to the outside area.

Besides, the signal line 103 is not crossed the power supply module to cause the interferences of the signals. This invention is also applied to the other kinds of digital flat panel display, for example like the liquid crystal display (LCD), the plasma display panel (PDP) and the surface-conduction electron-emitter display (SED), etc.

The signal-input terminal 32 of the digital flat panel display has additional portion to be connected with the VGA signal-input terminal, the USB signal-input terminal and the sound-input signal to enhance the convenience of the operation.

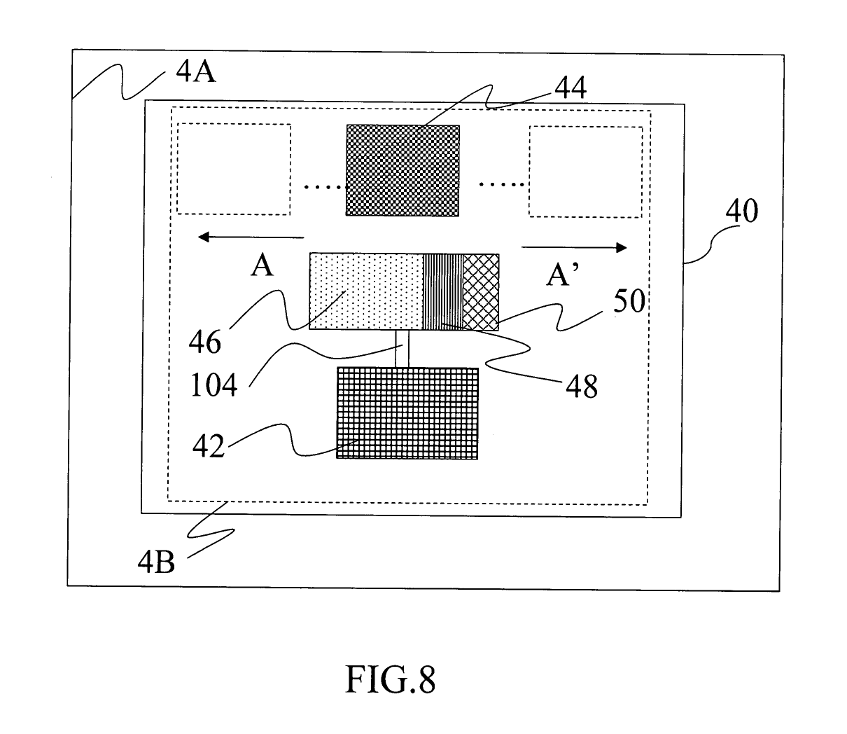

FIG. 8 is a diagram illustrating the layout of the digital flat panel display in accordance with one embodiment of the present invention. The digital flat panel display includes a case 4A, a display module 40 and an electrical control system 4B. The electrical control system 4B includes a signal-input terminal 42 for receiving signals, a power supply module 44 transforms a power source and provides the power source for signals operation, and a signal transform module 46 converts the analog signals to the digital signals. A signal input/output module 48 processes the I/O signals. A TV box module 50 is located between the signal-input terminal 42 and the power supply module 44 for processing the source of the TV signals.

In one embodiment, the display module 40 is rotated 180 degree so as to rearrange the signal-input terminal 42 on the lower position of the display module 40 and the power supply module 44 on the upper position of the display module 40. Besides, the signal transform module 46, the signal input/output module 48 and the TV box module 50 are between the signal-input terminal 42 and the power supply module 44. In addition, the display module 40 controls the image to return the image back to the original direction by an electrical firmware (not shown).

Accordingly, a signal line 104 is not crossed the power supply module 44 to cause the interferences when transmitting the signals. Besides, the signals are not weakness with long transmitting distance. Further more, the power supply module 44 does not produce and accumulate the heats that shorten the lifetime of the digital flat panel display during operation.

Therefore, according to the spirit of one embodiment, the power supply module 44 is configured at the upper area of the display modules 40 along the direction of the arrow A and A′ to make the heat dissipate to the outside area directly for avoiding accumulating the heat, and the signal line 104 are not crossed the power supply module 44 to cause the interferences.

The signal input module of the digital panel display has additional portion to be connected with the AV signal-input terminal, the S signal-input terminal and the USB signal-input terminal. This invention is also applied to other kinds of television, like the LCD TV, the PDP TV and the SED TV, etc. to enhance the convenience of the operation.

Accordingly, the display module is rotated 180 degree so as to rearrange the signal-input terminal on the lower position of the display module, and the power supply module is on the upper position of the display module. Besides, the signal transform module, the signal input/output module and the TV box module are between the signal-input terminal and the power supply module. Finally, an electrical firmware is configured inside the digital flat panel display to control the image returning to the original direction.

Therefore, this invention can shorten the distance from the signal-input terminal to the signal transform module for decreasing the weakness of the signals and interferences. The heat is dissipated from the power supply module to avoid the electronic components broken, and the lifetime of the digital flat panel display is increased.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A structure of digital flat panel display including a case, a display module and an electrical control system, said electrical control system comprising:
a signal-input terminal connected to said display module for receiving signals resource;
a signal input/output module connected to said display module and configured at the upper area of said signal-input terminal for processing the I/O signals;
a signal transform module connected to said display modules and configured at the upper area of said signal-input terminal for converting the analog signals to the digital signals; and
a power supply module connected to said display module and configured at the upper area of any one position of said signal transform module and said signal input/output module for transforming a power source and providing the power source.

2. The structure of digital flat panel display according to claim 1, wherein said digital flat panel display further comprises a firmware for controlling the image return to original direction.

3. The structure of digital flat panel display according to claim 1, wherein said digital flat panel display is a liquid crystal display (LCD), a plasma display panel (PDP) or a surface-conduction electron-emitter display (SED).

4. The structure of digital flat panel display according to claim 1, wherein said signal-input terminal is a VGA signal-input terminal, a USB signal-input terminal or a sound-input signal terminal.

5. A structure of digital flat panel display including a case, a display module and an electrical control system, said electrical control system comprising:
a signal-input terminal connected to said display module for receiving signals resource;
a signal input/output module connected to said display module and configured at the upper area of said signal-input terminal for processing the I/O signals;
a TV box module connected to said display module and configured at the upper area of said signal-input terminal;
a signal transform module connected to said display modules and configured at the upper area of said signal-input terminal for converting the analog signals to the digital signals; and
a power supply module connected to said display module and configured at the upper area of any one position of said signal transform module, said signal input/output module and said TV box module for transforming a power source and providing the power source.

6. The structure of digital flat panel display according to claim 5, wherein said digital flat panel display further comprises a firmware for controlling the image return to original direction.

7. The structure of digital flat panel display according to claim 5, wherein said digital flat panel display is a liquid crystal display (LCD) TV, a plasma display panel (PDP) TV or a surface-conduction electron-emitter display (SED) TV.

8. The structure of digital flat panel display according to claim 5, wherein said signal-input terminal is an AV signal-input terminal, an S signal-input terminal, a USB signal-input terminal or a VGA signal-input terminal.
